(19) United States
(12) Patent Application Publication
(10) Pub. No.: US 2025/0381743 A1
(43) Pub. Date: Dec. 18, 2025

(54) Method for Post-Processing Thermoplastic Parts

(71) Applicant: Additive Manufacturing Technologies Limited, Sheffield, South Yorkshire (GB)

(72) Inventors: Chinemelum Nedolisa, Sheffield, South Yorkshire (GB); Konstantin Rybalcenko, Sheffield, South Yorkshire (GB); Joseph Crabtree, Sheffield, South Yorkshire (GB)

(21) Appl. No.: 18/881,034

(22) PCT Filed: Jul. 3, 2023
(86) PCT No.: PCT/GB2023/051745

§ 371 Date: Jan. 3, 2025

(30) Foreign Application Priority Data
Jul. 5, 2022 (GB) 2209856.0
Nov. 2, 2022 (GB) 2216288.7

(51) Int. Cl. B29C 71/00; B29C 64/30; B33Y 40/20

(52) U.S. Cl. CPC B29C 71/0009; B29C 64/30; B33Y 40/20

(57) ABSTRACT

According to the present disclosure, there is provided a method for processing a thermoplastic part using a carboxylic ester solvent. Advantageously, it has been found that carboxylic esters provide an effective and more environmentally friendly alternative to traditional alcohol-based solvents used for processing thermoplastic parts.

### PRIORITY CLAIM

The present application is a U.S. National Stage patent application of International Patent Application No. PCT/GB2023/051745, filed Jul. 3, 2023, which claims priority to United Kingdom Patent Application No. 2209856.0, filed Jul. 5, 2022, and United Kingdom Patent Application No. 2216288.7, filed Nov. 2, 2022, the benefit of which is claimed and the disclosures of which are incorporated herein by reference in their entirety.

### FIELD

The present invention relates to a method of post-processing a thermoplastic part and the use of a carboxylic ester for performing the same.

### BACKGROUND

Additive manufacturing techniques are becoming increasingly prevalent in modern industry. However, a potential drawback of current additive manufacturing methods is that parts made using such methods can exhibit a rough and castellated surface finish due to the layer-by-layer processing methodology. It has also been found that parts manufactured via other manufacturing techniques can also exhibit sub-optimal surface textures and appearances.

To address this issue, in recent years there has been a significant increase in technologies designed to improve the surface finish of thermoplastic parts.

Current methods for smoothing such parts typically involve dissolving the rough surface of the part with an alcohol-based solvent to allow the surface to re-flow, thereby obtaining a smoothing effect. However, it has been found that many existing alcohol-based solvents are halogenated and/or come from benzene derivatives.

Halogenated compounds are not found in nature and are therefore very difficult to break down. This means that they tend to be extremely persistent in the environment which can lead to contamination of local ecosystems as well as wider environmental problems, such as the depletion of the ozone layer. As such, halogenated solvents require extensive and expensive treatment to avoid contaminating the environment.

Meanwhile, benzene derivatives are known carcinogens and can be harmful to animal and plant life. Consequently, the use of such derivatives is often tightly regulated and may be prohibited in some applications/jurisdictions.

It is therefore an aim of the present disclosure to provide an alternative range of solvents which are capable of processing thermoplastic parts.

### SUMMARY

According to a first aspect of the present disclosure, there is provided a method for processing a thermoplastic part comprising the steps of:
a) providing a thermoplastic part;
b) providing a fluid for post-processing the thermoplastic part in order to improve the surface finish of the thermoplastic part, wherein the fluid comprises at least one carboxylic ester;
c) a heating step, wherein the fluid is heated; and
d) an application step, wherein the heated fluid is applied to a surface of the thermoplastic part.

Advantageously, it has been found that carboxylic esters provide an effective and more environmentally friendly alternative to traditional alcohol-based solvents for processing thermoplastic parts.

In exemplary embodiments, the carboxylic ester is a cyclic carboxylic ester (lactone).

Advantageously, it has been found that cyclic carboxylic esters are a particularly effective alternative to traditional alcohol-based solvents for processing thermoplastic parts.

In exemplary embodiments, the cyclic carboxylic ester has the following structure:
wherein n is 2 to 10, each CH2 group may be optionally independently substituted with one or two substituents selected from the group consisting of alkyl, alkenyl, alkynyl, alkoxy, hydroxy, and carboxylates.

In exemplary embodiments, the cyclic carboxylic ester comprises a 4-membered ring.

Advantageously, cyclic carboxylic esters having a 4-membered ring structure exhibit improved stability when compared to cyclic carboxylic esters having ring structures with less than 4 members.

In exemplary embodiments, the cyclic carboxylic ester comprises a four (β-lactone), five (γ-lactone), six (δ-lactone) or seven (ε-lactone) membered ring.

Advantageously, cyclic carboxylic esters having four, five, six or seven membered ring structures tend to be more stable and are easier to synthesise when compared with cyclic carboxylic esters having differently membered ring structures.

In exemplary embodiments, the cyclic carboxylic ester comprises a 5-membered ring structure (γ-lactone).

Advantageously, cyclic carboxylic esters having a 5-membered ring structure have been found to be the most stable lactones for use in this application.

In exemplary embodiments, the cyclic carboxylic ester is γ-Valerolactone.

Advantageously, γ-Valerolactone is plant-based and can be manufactured from cellulosic biomass. As such, unlike benzene derivates, γ-Valerolactone is biodegradable and its manufacture does not require the use of crude oil.

Furthermore, γ-Valerolactone is non-halogenated and exhibits a low acute toxicity towards aquatic organisms. As such, γ-Valerolactone provides a more sustainable and environmentally friendly alternative when compared with traditional solvents used for smoothing thermoplastic materials.

In exemplary embodiments, the cyclic carboxylic ester is γ-Butyrolactone.

In exemplary embodiments, the cyclic carboxylic ester is ethylated γ-butyrolactone.

In exemplary embodiment, the cyclic carboxylic ester is propylated γ-butyrolactone.

In exemplary embodiments, the cyclic carboxylic ester is γ-Caprolactone.

In exemplary embodiments, the cyclic carboxylic ester is selected from one of: β-Propiolactone, δ-pentalactone, γ-hexalactone, γ-Valerolactone, ε-Caprolactone or γ-Caprolactone.

In exemplary embodiments, the thermoplastic part may comprise a polar polymer.

In exemplary embodiments, the thermoplastic part may comprise poly(vinyl chloride), poly(methyl methacrylate), polyamide, polyurethane and/or combinations thereof.

In exemplary embodiments, the thermoplastic material may comprise one or more of the following thermoplastics: Polyamide (PA); Polylactic Acid (PLA); Polysulfone (PSU); Polyphenyl Sulfone (PPSU); Polyether Imide (PEI); Thermoplastic Polyurethane (TPU); Acrylonitrile Butadiene Styrene (ABS); Polymethyl Methacrylate (PMMA); Polycarbonate (PC), and/or Polyethylene Terephthalate (PET).

In exemplary embodiments, the part may comprise a Polyamide.

In exemplary embodiments, the part may comprise Polyamide 12.

In exemplary embodiments, the part may comprise Polyamide 66.

In exemplary embodiments, the part may comprise Polyamide 46.

In exemplary embodiments, the part may comprise Polyamide 11.

In exemplary embodiments, the part may comprise a thermoplastic elastomer.

In exemplary embodiments, the part may comprise Thermoplastic Polyurethane (TPU).

In exemplary embodiments, the part may comprise a Polylactic Acid (PLA).

In exemplary embodiments, the part may comprise a Polysulfone (PSU).

In exemplary embodiments, the part may comprise a Polyphenyl Sulfone (PPSU).

In exemplary embodiments, the part may comprise Polyether Imide (PEI).

In exemplary embodiments, the part may comprise Acrylonitrile Butadiene Styrene (ABS).

In exemplary embodiments, the part may comprise Polymethyl Methacrylate (PMMA).

In exemplary embodiments, the part may comprise a Polycarbonate (PC).

In exemplary embodiments, the part may comprise Polyethylene Terephthalate (PET).

In exemplary embodiments, the thermoplastic part may be an additively manufactured part.

In exemplary embodiments, the thermoplastic part may be a powder-based additively manufactured part.

In exemplary embodiments, the additively manufactured part may be a filament-based additively manufactured part.

In exemplary embodiments, the heating step comprises heating the fluid to a temperature in the range of about 100° C. to about 300° C.

Advantageously, it has been found that heating the fluid to a temperature in the range of 100° C. to 300° C. provides optimal conditions for processing thermoplastic parts without causing damage to said parts due to overheating.

In exemplary embodiments, the heated fluid is applied to the surface of the thermoplastic part for an immersion time in the range of about 10 seconds to about 1 hour.

Advantageously, it has been found that an immersion time in the range of 10 seconds to 1 hour is optimal for processing thermoplastic parts without causing damage to said parts due to overexposure to the solvent.

In exemplary embodiments, the heated fluid is applied to the surface of the thermoplastic part for an immersion time in the range of about 10 seconds to about 5 minutes.

Advantageously, it has been found that an immersion time in the range of 10 seconds to 5 minutes is even more optimal for processing thermoplastic parts without causing damage to said parts due to overexposure to the solvent.

In exemplary embodiments, the fluid is provided as a liquid.

In exemplary embodiments, the application step comprises submerging the thermoplastic part into said liquid.

In exemplary embodiments, the heating step comprises heating the liquid to a temperature in the range of about 140° to about 200° C.

Advantageously, it has been found that processing at temperatures in the range of 160° C. to 200° C. are particularly effective when using liquid solvents.

In exemplary embodiments, step a) comprises placing the thermoplastic part into a processing chamber, step c) comprises heating the fluid so as to cause the fluid to vaporise, and step d) comprises introducing the vaporised fluid into the processing chamber and condensing the vaporised fluid onto the surface of the thermoplastic part contained therein.

Advantageously, vapour processing methods (such as the one described above) provide a more controllable and more easily automated alternative to traditional liquid-based processing methods.

In exemplary embodiments, the method comprises heating the vapourised fluid to a temperature in the range of about 120° C. to about 180° C.

Advantageously, it has been found that processing at temperatures in the range of 150° C. to 180° C. are particularly effective when using vapour processing methods.

In exemplary embodiments, an interior of the processing chamber is maintained at a pressure which is less than 100 kPa (1 Bar).

Advantageously, maintaining the interior of the processing chamber at a pressure below 1 Bar allows the solvent to be vapourised at lower temperatures than would otherwise be possible when performing the method at atmospheric pressure. This helps to reduce the likelihood of causing thermal damage to the thermoplastic parts during processing.

In exemplary embodiments, the interior of the processing chamber is maintained at a pressure in the range of about 1 kPa to about 50 kPa (about 10 mBar to about 500 mBar).

Advantageously, it has been found that pressures in the range of 10 mBar to 500 mBar are particularly effective when using vapour processing methods.

In exemplary embodiments, the interior of the processing chamber is maintained at a pressure in the range of about 5 kPa to about 30 kPa (about 50 mBar to about 300 mBar).

Advantageously, it has been found that pressures in the range of 50 mBar to 300 mBar are even more effective when using vapour processing methods.

In exemplary embodiments, the method further comprises, after step d):
e) re-applying a negative pressure to the interior of the processing chamber so as to evaporate the condensed fluid from the surface of the thermoplastic part.

Advantageously, re-applying a negative pressure to the interior of the processing chamber provides an easily controllable and automatable method for removing excess solvent from the surface of the part, whilst also reducing the likelihood of causing damage to the part during the drying step due to excessive temperatures.

In exemplary embodiments, the method further comprises, after step d):
f) removing the heated fluid from the surface of the thermoplastic part; and
g) re-applying the or a heated fluid to the surface of the thermoplastic part.

Advantageously, it has been found that the surface finish of the thermoplastic part can be further improved via repeating the process.

In exemplary embodiments, the material of the thermoplastic part comprises a functional group having a dipole moment greater than 0 Debye.

In exemplary embodiments, the material of the thermoplastic part comprises a functional group having a dipole moment greater than 0.5 Debye.

In exemplary embodiments, the at least one carboxylic ester is a biodegradable carboxylic ester.

In exemplary embodiments, the at least one carboxylic ester is a biosolvent.

According to a second aspect of the present disclosure, the use of a carboxylic ester for smoothing a thermoplastic part is provided.

In exemplary embodiments, the carboxylic ester is a cyclic carboxylic ester (lactone).

Advantageously, it has been found that cyclic carboxylic esters are a particularly effective alternative to traditional alcohol-based solvents for processing thermoplastic parts.

In exemplary embodiments, the cyclic carboxylic ester has the following structure:
wherein n is 2 to 10, each CH2 group may be optionally independently substituted with one or two substituents selected from the group consisting of alkyl, alkenyl, alkynyl, alkoxy, hydroxy, and carboxylates.

In exemplary embodiments, the cyclic carboxylic ester comprises a 4-membered ring.

Advantageously, cyclic carboxylic esters having a 4-membered ring structure exhibit improved stability when compared to cyclic carboxylic esters having ring structures with less than 4 members.

In exemplary embodiments, the cyclic carboxylic ester may comprise a four membered ring (β-lactone), a five membered ring (γ-lactone), a six membered ring (δ-lactone) or a seven membered ring (ε-lactone) membered ring.

Advantageously, cyclic carboxylic esters having four, five, six or seven membered ring structures tend to be more stable and are easier to synthesise when compared with cyclic carboxylic esters having differently membered ring structures.

In exemplary embodiments, the cyclic carboxylic ester comprises a 5-membered ring structure (γ-lactone).

Advantageously, cyclic carboxylic esters having five membered ring structures have been found to be the most stable lactones for use in this application.

In exemplary embodiments, the cyclic carboxylic ester is γ-Valerolactone.

Advantageously, γ-Valerolactone is plant-based and can be manufactured from cellulosic biomass. As such, unlike benzene derivates, γ-Valerolactone is biodegradable and its manufacture does not require the use of crude oil.

Furthermore, γ-Valerolactone is non-halogenated and exhibits a low acute toxicity towards aquatic organisms. As such, γ-Valerolactone provides a more sustainable and environmentally friendly alternative when compared with traditional solvents used for smoothing thermoplastic materials.

In exemplary embodiments, the cyclic carboxylic ester is γ-Butyrolactone. In exemplary embodiments, the cyclic carboxylic ester is ethylated γ-butyrolactone.

In exemplary embodiment, the cyclic carboxylic ester is propylated γ-butyrolactone.

In exemplary embodiments, the cyclic carboxylic ester is γ-Caprolactone.

In exemplary embodiments, the cyclic carboxylic ester is selected from one of: β-Propiolactone, δ-pentalactone, γ-hexalactone, γ-Valerolactone, ε-Caprolactone or γ-Caprolactone.

In exemplary embodiments, the thermoplastic part may comprise a polar polymer.

In exemplary embodiments, the thermoplastic part may comprise poly(vinyl chloride), poly(methyl methacrylate), polyamide, polyurethane and/or combinations thereof.

In exemplary embodiments, the thermoplastic material may comprise one or more of the following thermoplastics: Polyamide (PA); Polylactic Acid (PLA); Polysulfone (PSU); Polyphenyl Sulfone (PPSU); Polyether Imide (PEI); Thermoplastic Polyurethane (TPU); Acrylonitrile Butadiene Styrene (ABS); Polymethyl Methacrylate (PMMA); Polycarbonate (PC), and/or Polyethylene Terephthalate (PET).

In exemplary embodiments, the part may comprise a Polyamide.

In exemplary embodiments, the part may comprise Polyamide 12.

In exemplary embodiments, the part may comprise Polyamide 66.

In exemplary embodiments, the part may comprise Polyamide 46.

In exemplary embodiments, the part may comprise Polyamide 11.

In exemplary embodiments, the part may comprise a thermoplastic elastomer.

In exemplary embodiments, the part may comprise Thermoplastic Polyurethane (TPU).

In exemplary embodiments, the part may comprise a Polylactic Acid (PLA).

In exemplary embodiments, the part may comprise a Polysulfone (PSU).

In exemplary embodiments, the part may comprise a Polyphenyl Sulfone (PPSU).

In exemplary embodiments, the part may comprise Polyether Imide (PEI).

In exemplary embodiments, the part may comprise Acrylonitrile Butadiene Styrene (ABS).

In exemplary embodiments, the part may comprise Polymethyl Methacrylate (PMMA).

In exemplary embodiments, the part may comprise a Polycarbonate (PC).

In exemplary embodiments, the part may comprise Polyethylene Terephthalate (PET).

In exemplary embodiments, the material of the thermoplastic part comprises a functional group having a dipole moment greater than 0 Debye.

In exemplary embodiments, the material of the thermoplastic part comprises a functional group having a dipole moment greater than 0.5 Debye.

In exemplary embodiments, the at least one carboxylic ester is a biodegradable carboxylic ester.

In exemplary embodiments, the at least one carboxylic ester is a biosolvent.

In exemplary embodiments, the thermoplastic part may be an additively manufactured part.

In exemplary embodiments, the additively manufactured part may be a powder-based additively manufactured part.

In exemplary embodiments, the additively manufactured part may be a filament-based additively manufactured part.

We consider the term “alpha (α) lactone” to be defined as a cyclic carboxylic ester having a 3-membered ring structure; that is, one carbon atom between the C═O group and the —O— group.

We consider the term “beta (β) lactone” to be defined as a cyclic carboxylic ester having a 4-membered ring structure; that is, two carbon atoms between the C═O group and the —O— group.

We consider the term “gamma (γ) lactone” to be defined as a cyclic carboxylic ester having a 5-membered ring structure; that is, three carbon atoms between the C═O group and the —O— group.

We consider the term “delta (δ) lactone” to be defined as a cyclic carboxylic ester having a 6-membered ring structure that is, four carbon atoms between the C═O group and the —O— group.

We consider the term “heating” to be defined as increasing a temperature significantly above (e.g., by more than 5° C. to 10° C.) an ambient (e.g., room) temperature.

We consider the term “fluid” to encompass both liquids and gases.

We consider the term “post-processing” to be defined as processing a part after the part has been built, where the post-processing is for the purposes of changing at least one physical property (e.g., surface roughness) of the part after the part has been built.

We consider the term “polar material” to be defined as a material or compound comprising one or more functional groups having a dipole moment which is greater than 0 Debye (D), optionally greater than 0.5 D. In other words, polar materials contain functional groups with distinct regions of positive and negative charge. A Debye is defined as the electric dipole moment resulting from two equal but opposite charges of absolute magnitude 1010 statcoulomb separated by 1 ångström. The dipole moment may be calculated or measured using methods known in the art.

### BRIEF DESCRIPTION OF THE DRAWINGS

Embodiments of the present disclosure will now be described with reference to the accompanying drawings, in which:

FIG. 1 is an apparatus for smoothing a thermoplastic part according to a method of the present disclosure;

FIG. 2 is a flow diagram depicting a method of smoothing a thermoplastic part according to an aspect of the present disclosure;

FIG. 3a is an image showing a powder-based sample of Polyamide 12 before and after being subjected to a smoothing process using a γ-Valerolactone solvent according to a method of the present disclosure;

FIG. 3b is an image showing a powder-based sample of Polyamide 12 before and after being subjected to a smoothing process using a γ-Butyrolactone solvent according to a method of the present disclosure;

FIG. 3c is an image showing a powder-based sample of Thermoplastic Polyurethane before and after being subjected to a smoothing process using a γ-Valerolactone solvent according to a method of the present disclosure;

FIG. 3d is an image showing a powder-based sample of Thermoplastic Polyurethane before and after being subjected to a smoothing process using a γ-Butyrolactone solvent according to a method of the present disclosure;

FIG. 3e is an image showing a powder-based sample of Thermoplastic Polyurethane before and after being subjected to a smoothing process using a γ-Caprolactone solvent according to a method of the present disclosure;

FIG. 3f is an image showing a powder-based sample of Polyamide 12 before and after being subjected to a smoothing process using a Methyl 5-(dimethylamino)-2-methyl-5-oxopentanoate solvent according to a method of the present disclosure;

FIG. 3g is an image showing a powder-based sample of Thermoplastic polyurethane before and after being subjected to a smoothing process using a Methyl 5-(dimethylamino)-2-methyl-5-oxopentanoate solvent according to a method of the present disclosure;

FIG. 3h is an image showing a filament-based sample of Polyphenylene sulfide before and after being subjected to a smoothing process using a Methyl 5-(dimethylamino)-2-methyl-5-oxopentanoate solvent according to a method of the present disclosure;

FIG. 3i is an image showing an injection moulded (non-AM) sample of Polyphenylsulfone (PPSU) before and after being subjected to a smoothing process using a γ-Valerolactone solvent according to a method of the present disclosure;

FIG. 4 is an alternative apparatus for smoothing a thermoplastic part according to a method of the present disclosure; and

FIG. 5 is a flow diagram depicting an alternative method of smoothing a thermoplastic part according to an aspect of the present disclosure.

### DETAILED DESCRIPTION

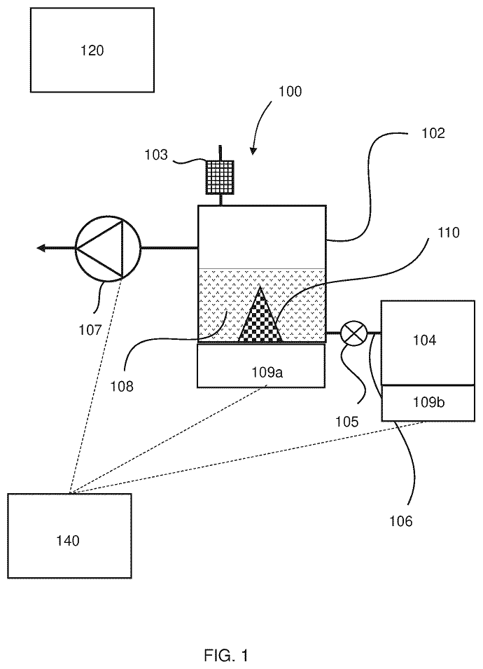

FIG. 1 shows an apparatus 100 for post-processing a thermoplastic part according to an embodiment of the present disclosure.

The apparatus 100 illustrated in FIG. 1 is configured for processing parts 110 using a solvent vapour 108 and is made up of a gas-tight processing chamber 102, a reservoir 104 and a vapour distribution system 106.

The gas-tight processing chamber 102 is sized to be able to receive the part 110 therein and is fluidically-connected to the reservoir 104 via the vapour distribution system 106.

The vapour distribution system 106 is provided in the form of a pipe having a first end located at an outlet of the reservoir 104 and having a second end located at an inlet of the processing chamber 102. In use, the vapour distribution system 106 is configured to deliver the solvent vapour 108 from the reservoir 104 into the processing chamber 102.

The vapour distribution system 106 also includes a valve 105 to enable the introduction of the solvent vapour 108 into the processing chamber 102 to be controlled.

The apparatus 100 further includes a vacuum pump 107 which is in fluid communication with an interior of the processing chamber 102. The vacuum pump 107 is in operable communication with a controller 140 such that, in use, the vacuum pump 107 can be controlled to adjust the pressure applied to the interior of the processing chamber 102 as may be required during the process.

The apparatus 100 also includes a pair of heating elements 109a, 109b. The heating elements 109a, 109b are in operable communication with the or a controller 140 such that, in use, the heating elements 109a, 109b can be controlled to heat the solvent as may be required during processing.

The first heating element 109a forms part of a wall of the processing chamber 102 and is configured to heat the solvent vapour within the processing chamber 102 to a desired temperature as shall be described in greater detail below. The second heating element 109b is associated with the reservoir 104 and is configured to vaporise the solvent contained within the reservoir prior to its introduction into the processing chamber 102.

In exemplary embodiments, the apparatus 100 may form part of an additive manufacturing system, which may also include an additive manufacturing apparatus 120 configured for building the additively manufactured part 110, prior to the part 110 being post-processed by the apparatus 100. In some embodiments, the additive manufacturing apparatus 120 may be a powder-based additive manufacturing apparatus such as a laser sintering apparatus or a multi-jet fusion apparatus or may be a filament-based additive manufacturing apparatus such as fused filament apparatus.

It shall also be appreciated that in alternative embodiments, the apparatus 100 may be provided as a separate and discrete system, and so the apparatus 100 does not need to be associated with an additive manufacturing apparatus.

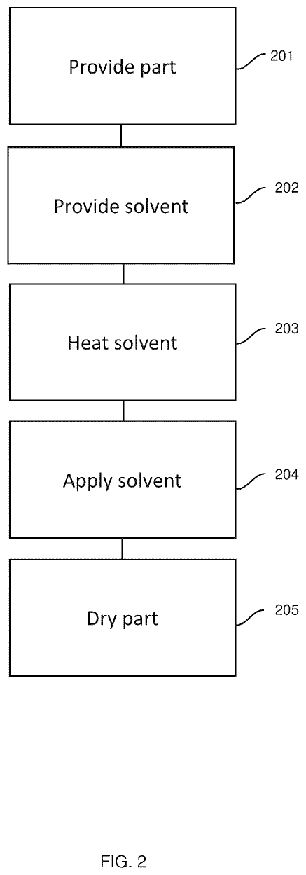

A method of post-processing an additively manufactured part according to an embodiment of the present disclosure shall now be described with reference to FIGS. 1 and 2.

In some embodiments, the additively manufactured part may be a powder-based additively manufactured part. In other words, the additively manufactured part may be obtained from a powder-based additive manufacturing technique, such as Selective Laser Sintering or Multi-Jet Fusion.

It is important to note that during powder-based additive manufacturing processes, such as Selective Laser Sintering or Multi-Jet Fusion, a first layer of powder build material is laid down onto a build bed. The first layer of powder build material is then sintered to form the first sintered layer of the additively manufactured part. A second layer of powder build material is then laid onto the first sintered layer. The second layer of powder build material is then subsequently sintered to form a second sintered layer of the additively manufactured part. Subsequent layers are then applied and sintered in the same fashion thereafter, until a part having a desired shape has been built from multiple sintered layers.

Alternately, in some embodiments the additively manufactured part may be a filament-based additively manufactured part. In other words, the additively manufactured part may be obtained from a filament-based additive manufacturing technique, such as fused filament processing.

During the fused filament processing, a filament material is heated and extruded through a nozzle which selectively deposits the material on the build platform. Once the first layer is deposited, either the platform is moved lower, or the nozzle is lifted to extrude the consecutive layers until the desired shape is constructed.

It has been found that the material at any surface of the additively manufactured part may often exhibit a different, less favourable structure to that of the material which is beneath said surface. As such, the presence of less favourable structures at the surface of a given part can result in additively manufactured parts having a rough surface finish. The material at the surface of the part can exhibit a looser structure/morphology, which is typically much weaker than the material beneath the surface of the additively manufactured part. It has been found that the less favourable material at the surface of the part can be processed using one or more carboxylic esters, and subsequently an improved surface finish can be achieved.

It shall also be appreciated that whilst the methods described below are described as being performed on an additively manufactured part, it shall also be appreciated that the methods and apparatuses described within this application are also suitable for processing thermoplastic parts obtained via other types of manufacturing method including, but not limited to, injection moulding, compression moulding, thermoforming, extrusion and computer numerically controlled (CNC) machining methods such as milling, single and multi-point cutting and abrasive machining.

It shall also be appreciated that the parts obtained following the post-processing methods described herein can be used in a variety of different applications including, but not limited to, uses in the medical, automotive, aerospace, construction, transportation, and consumer product sectors.

At a first step 201 of the method, the raw-state additively manufactured part 110 is provided (i.e., in the state that it was immediately after the build operation).

In the embodiment illustrated in FIGS. 1 and 2, the additively manufactured part 110 is a thermoplastic part obtained from a powder-based additive manufacturing method, such as Selective Laser Sintering or Multi-Jet Fusion, as has been specified above. However, it shall be appreciated that in other embodiments, other suitable powder or filament-based additive manufacturing methods may be used.

It has been found that the aforementioned method can also be used for processing polar materials. A polar material is a material comprising polar polymers. Polar polymers contain functional polar groups with distinct regions of positive and negative charge. That is, they contain functional groups which have a polar moment greater than 0 D, optionally greater than 0.5 D, such as polyamides. Advantageously, the polar solvents described herein have superior solvent ability when paired with polar polymers since polar solvents can form hydrogen bonds with polar polymers.

In the illustrated embodiment, the additively manufactured part comprises Polyamide 12. However, it shall be appreciated that in other embodiments, other suitable materials may be processed using the aforementioned method.

For example, in some embodiments, the additively manufactured part may comprise a different grade of Polyamide including, but not limited to, Polyamide 66, Polyamide 46 and/or Polyamide 11.

It has also been found that the aforementioned method can be used for processing other thermoplastic materials such as thermoplastic elastomers. A thermoplastic elastomer is a class of copolymers that consists of materials with both thermoplastic and elastomeric properties.

As such, in some embodiments, the additively manufactured part may comprise Thermoplastic Polyurethane (TPU), thermoplastics based upon poly(vinyl chloride), poly(methyl methacrylate), polyamides, and polyurethanes. However, it shall also be appreciated that in other embodiments, other suitable thermoplastic elastomers may be processed using the aforementioned method.

For example, in some embodiments, the additively manufactured part may comprise styrene block copolymers (such as polystyrene and polybutadiene), polyolefins (such as polyethylene and polypropylene), thermoplastic copolyesters (such as polyethylene terephthalate), rubbers and/or elastomeric alloys.

Examples of materials of which the additively manufactured part 110 may comprise include, but are not limited to, Thermoplastic Polyurethane (TPU) and various derivatives like Quadrathane™ ARC, Polyamide 12, 61 11 and other derivatives such as glass, graphite or carbon reinforced Polyamide, Polycarbonate (PC), Polyphenylene sulfide (PPS) and its derivatives such as Carbon Fibre Reinforced PPS (or PPSCF), Polypropylene (PP), Polyvinylidene fluoride (PVDF), Polyether ether ketone (PEEK), Polyether ketone ketone (PEKK) and other derivatives such as Polyaryl ether ketone (PAEK), Ethylene propylene rubber (EDPM), Nitrile rubber (NBR), Thermoplastic elastometers (TPE), Polyether Imides (PEI) such as ULTEM™ 9085, ULTEM™ 1010, Polylactic Acid (PLA), Polysulfone (PSU), Polyphenyl Sulfone (PPSU), Acrylonitrile Butadiene Styrene (ABS), Polymethyl Methacrylate (PMMA), Polyethylene Terephthalate (PET) or the like.

At step 202 of the method, a fluid 108 is provided which comprises a carboxylic ester or a mixture of carboxylic esters. In the illustrated embodiment, the carboxylic ester is a cyclic carboxylic ester (sometimes referred to as lactones), namely γ-Valerolactone (such as γ-Valerolactone ReagentPlus®, 99% which is available from Sigma-Aldrich). However, it shall be appreciated that in other embodiments, other suitable carboxylic esters may be used.

Lactones contain a 1-oxacycloalkan-2-one structure (—C(═O)—O—). Exemplary lactones for use in the present disclosure have the following structure:
wherein n is 2 to 10. Each CH2 group may be optionally substituted with one more substituents. Exemplary substituents include alkyl, alkenyl, alkynyl, alkoxy, hydroxyl, carboxylic acid, nitro, and the like. The ring may be saturated or unsaturated. One or more heteroatoms may replace one or more carbon atoms of the ring.

Cyclic carboxylic esters having at least a four-membered ring structure tend to exhibit improved stability when compared to cyclic carboxylic esters having ring structures with fewer than four members, and so carboxylic esters having ring structures with at least four members tend to be preferred when performing the aforementioned method. Exemplary lactones with at least four members include β propiolactones, γ-butyrolactones, δ-pentalactones (also referred to as valerolactones), γ-hexalactone, ethylated γ-butyrolactone, propylated γ-butyrolactone, and ε hexalactones (also referred to as caprolactones) each of which may be optionally substituted with the one or more substituents as described above, and combinations thereof.

In some embodiments, the alkyl substituent is a straight or branched chain lower C1-15 lower alkyl, such as methyl, ethyl, propyl, butyl, hexyl, heptyl, octyl, decyl, dodecyl, pentadecyl and the like. In some embodiments, the alkenyl substituent is a straight or branched chain lower C1-15 lower alkenyl, such as ethenyl, propenyl, butenyl, hexenyl, heptenyl, octenyl, decenyl, dodecenyl, pentadecenyl and the like. In some embodiment, the alkynyl substituent is a straight or branched chain lower C1-15 lower alkynyl such as propynyl, butynyl, hexynyl, heptynyl, octynyl, decynyl, dodecynyl, pentadecynyl and the like. In some embodiments, the alkyoxy substituent is a straight or branched chain lower C1-15 alkoxy group such as methoxy, ethoxy, propoxy, butoxy, hexoxy, heptoxy, octoxy, decoxy, dodecyoxy, pentadecyoxy and the like. In some embodiments, the carboxylic acid substituent is a straight or branched chain C1-15 mono, di, or tri carboxylic acid, such as methanoic, ethanoic, propanoic, butanoic acid. In some embodiments, the halogen is a fluorine, chlorine, bromine, iodine or astatine group. Preferred substituents include a methyl group and an ethyl group.

In particular, the cyclic carboxylic esters comprising five (γ-lactone) and six (δ-lactone) membered rings have been found to be the most preferable. However, it shall also be appreciated that in some embodiments, the method may be performed using non-cyclic carboxylic esters.

Examples of suitable non-cyclic carboxylic esters may include but are not limited to compounds of the formula R2-C═O— O—R3, wherein R2 and R3are each independently selected from a straight or branched chain alkyl or alkoxy group with 1 to 6 carbons. Particularly preferred examples of non-cyclic carboxylic esters include, methyl acetate, methyl lactate, ethyl lactate, dimethyl glutarate, ethylacetate, 2-ethoxyethyl acetate, ethyl-3-ethoxypropionate, 2-ethylhexylacetate, 2-ethoxyethyl isobutyrate, isopropylacetate, propyl acetate, 2-methoxyethylacetate, butyl-acetate, Methyl 5-(dimethylamino)-2-methyl-5-oxopentanoate and combinations thereof.

In some embodiments, the fluids for use in the invention comprise biodegradable “green” solvents. Green solvents are environmentally friendly solvents, or biosolvents, which can be derived from the processing of agricultural crops. Green solvents were developed as a more environmentally friendly alternative to petrochemical solvents. Green solvents are biodegradable, non-carcinogenic, and non-toxic. Examples of suitable green solvents include the cyclic esters and non-cyclic esters described above.

The fluid 108, in the case of the illustrated embodiment γ-Valerolactone, is initially provided within the reservoir 104 of the apparatus 100. In some embodiments, the fluid 108 may be supplied to the reservoir in a liquid form and may then be subsequently heated by a dedicated heating apparatus (such as heating element 109b) associated with the reservoir 104, to vaporise the fluid 108 prior to introduction into the processing chamber 102. In alternative embodiments, the fluid 108 may be supplied to the reservoir in an already vaporised form.

Once at least some of the fluid 108 provided within the reservoir is in vapour form, the solvent vapour 108 is delivered from the reservoir 104 into the processing chamber 102 via opening the valve 105 of the vapour distribution system 106 and allowing the solvent vapour 108 to flow into the processing chamber 102.

Once the solvent vapour 108 has been introduced into the processing chamber 102, the solvent 108 may be further heated, via the heating element 109a, to a temperature suitable for overcoming the bonds between particles of the material at the surface of the additively manufactured part. The precise temperature to which the solvent 108 is heated varies based on the material being processed and the flashpoint of the solvent being used but is typically in the range of 100° C. to 300° C., with optimal results typically being achieved at temperatures in the range of 120° C. to 180° C.

For example, it has been found that optimal results can be obtained when processing additively manufactured parts comprising Polyamide 12 using γ-Valerolactone by heating the solvent to a temperature of approximately 150° C.

However, it shall be appreciated that for some materials with higher melting points, such as PPS, and for some solvents with higher boiling points, such as Methyl 5-(dimethylamino)-2-methyl-5-oxopentanoate, optimal results may be achieved at a higher range of temperatures, such as temperatures in the range of 120° C. to 280° C.

Furthermore, it shall also be appreciated that in some embodiments, the solvent 108 may be heated to a temperature suitable for overcoming the bonds between particles of the material at the surface of the additively manufactured part within the reservoir (prior to introduction into the processing chamber 102) and so further heating of the solvent vapour within the processing chamber may not be required.

In some embodiments, the vacuum pump 107 may also be operated during the process to apply a negative pressure to the interior of the processing chamber 102. Typically, the pressure within the processing chamber 102 is maintained below 100 kPa (1 bar). By creating a negative pressure environment within the processing chamber 102 it has been found that the solvent can be vaporised at lower temperatures than would otherwise be obtainable under atmospheric conditions. This helps to reduce the likelihood of the part becoming damaged due to temperature during the process.

Furthermore, the application of a negative pressure to the processing chamber 102 also aids in drawing the vapour 108 from the reservoir 104 and into the processing chamber 102 upon opening of the valve 105 at step 202.

The precise pressures which are applied to the interior of the processing chamber 102 tend to vary based on the thermodynamic characteristics of the solvent which is being used for a given process and based on the temperature conditions within the processing chamber 102. However, the pressure within the processing chamber during processing will typically be maintained in the range of 1 kPa to 50 kPa (10 mBar to 500 mBar), with optimal results typically being achieved at pressures in the range of 5 kPa to 30 kPa (50 mBar to 300 mBar).

For example, it has been found that optimal results can be obtained when processing additively manufactured parts comprising Polyamide 12 using γ-Valerolactone by maintaining the pressure within the processing chamber at approximately 20 kPa (200 mBar).

However, as set out in the experimental examples section below, it has also been found that samples of Thermoplastic polyurethane can be processed using γ-Valerolactone vapours at atmospheric pressure. As such, it shall be appreciated that in some embodiments, the vapour processing method may be performed at atmospheric pressure.

It will be understood that the temperature of the surface of the part 110 is initially lower than a condensation temperature of the solvent vapour 108 within the processing chamber 102. As such, any solvent vapour 108 which comes into contact with the surface of the part 110 will be subsequently cooled which will cause it to condense onto the surface of the part 110. In this manner, the vaporised solvent 108 can be applied onto the surface of the part 110.

In exemplary embodiments, the part 110 may also be cooled, for example using a blast chiller, prior to being placed into the processing chamber 102. This achieves a greater temperature different between the part 110 and the solvent vapour 108, which allows for more effective condensation (and hence application) of the solvent vapour 108 onto the surface of the part 110.

Furthermore, as increasing amounts of vaporised solvent 108 are introduced into the processing chamber 102 via the vapour distribution system 106, the pressure within the processing chamber 102 will also subsequently increase thereby causing more solvent to condense onto the surface of the part 110 (since at higher pressures, higher temperatures are required to vaporise a given solvent).

After application of the solvent vapour 108 onto the surface of the part 110 at step 204, the part 110 is then left for a period of time. It has been found that a period between 10 seconds and 1 hour is optimal to allow for post-processing of the part 110.

For example, it has been found that a processing time of approximately 20 seconds is optimal when processing additively manufactured parts comprising Polyamide 12 using γ-Valerolactone, although it shall be appreciated that processing times may vary dependent on the material and solvent used for a given process.

Once the desired processing time has elapsed, the part 110 is dried during step 205 in order to remove the solvent from the surface of the part 110 and thereby prevent any further processing which could adversely impact the quality of the part.

In the illustrated embodiment, step 205 is performed via re-applying a negative pressure, in this case a pressure of approximately 20 kPa (200 mBar) to the interior of the processing chamber via re-activating the vacuum pump 107 so as to cause any solvent present on the surface of the part to re-vaporise. The evaporated solvent 108 can then be evacuated from the processing chamber 102 to the external atmosphere via a filter, such as an active-carbon filter 103 illustrated in FIG. 1. However, it shall be appreciated that in some embodiments, other suitable drying methods (such as heating) may be used.

The dried part 110 is then removed from the processing chamber 102 thereby ending the process.

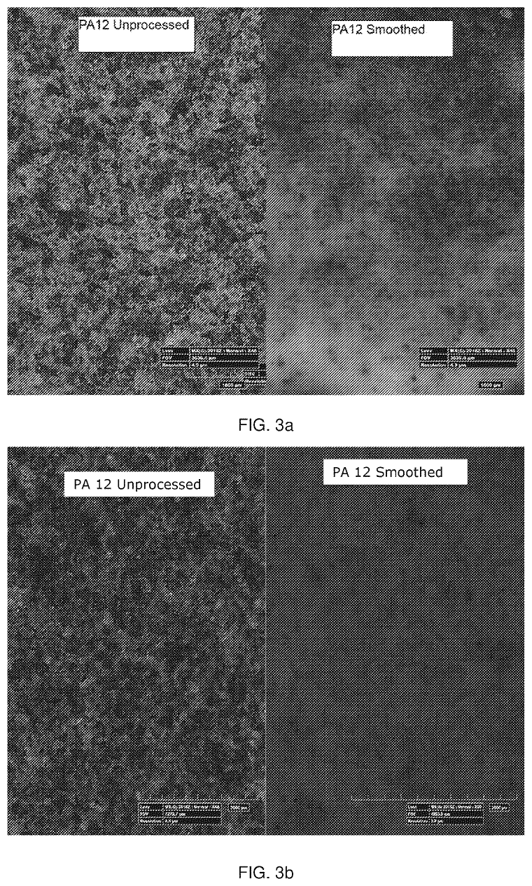

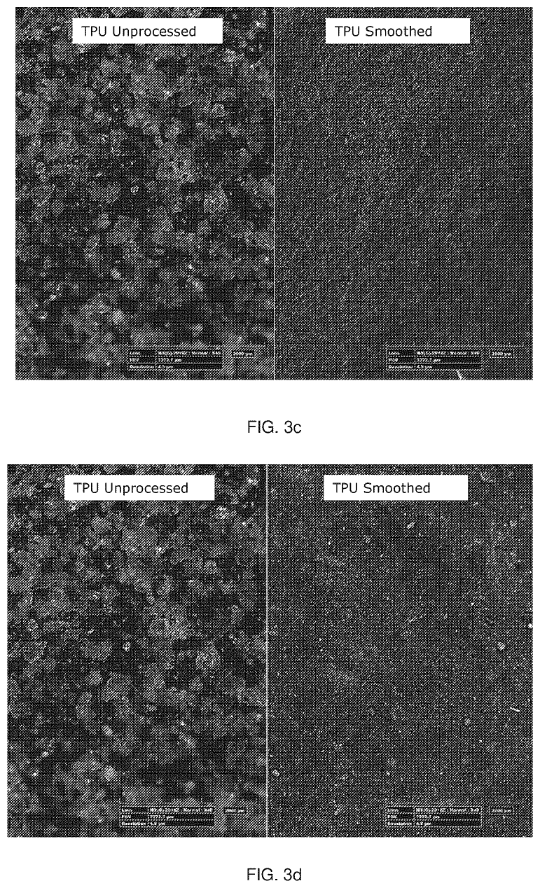

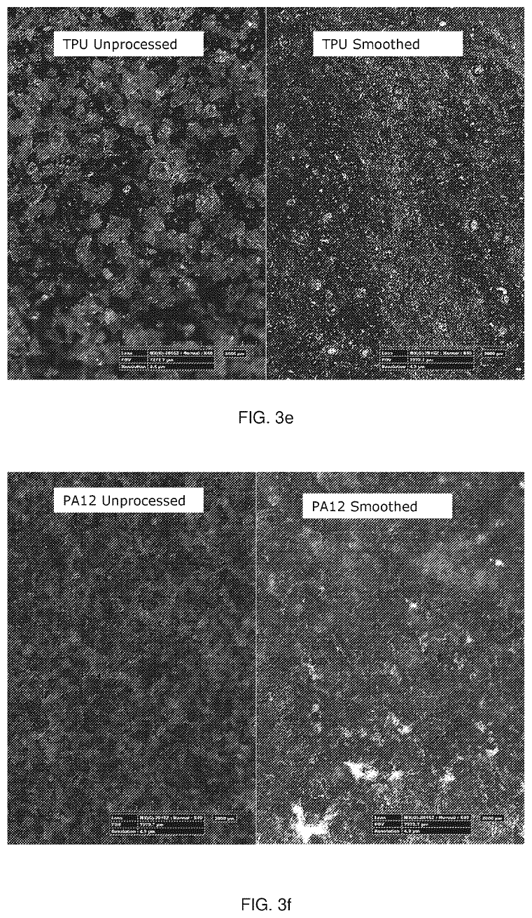

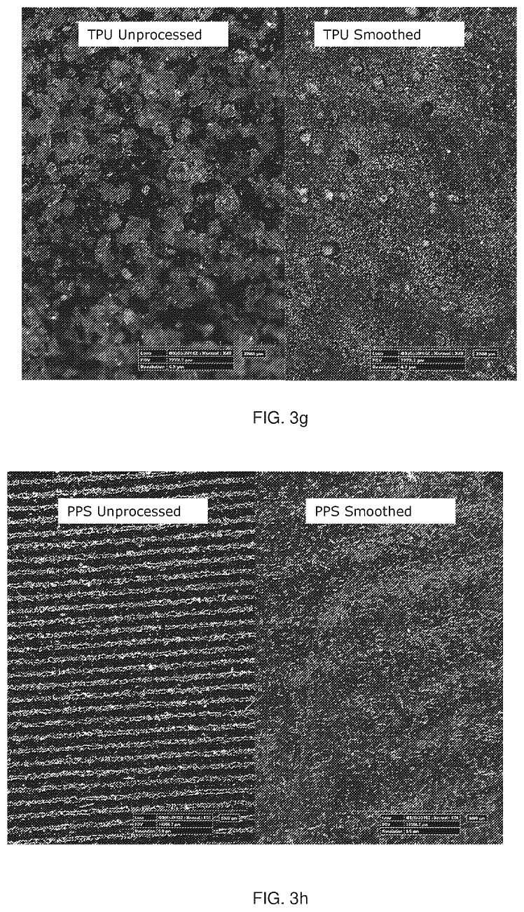

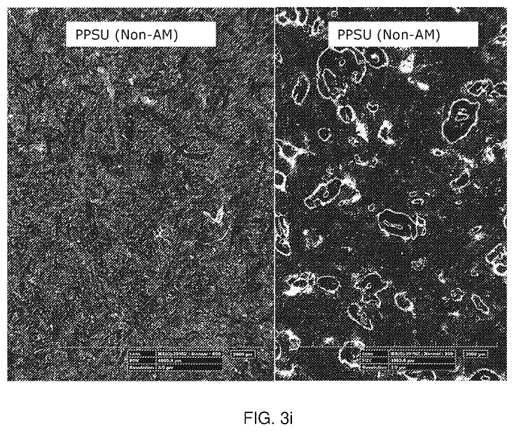

As a result of the aforedescribed process, an improved surface finish was observed in a variety of different parts processed using a variety of different solvents as is illustrated in FIGS. 3a to 3h.

In the microscopy image shown in FIG. 3a, the surface roughness of a powder-based additively manufactured part comprising Polyamide 12 was reduced using a γ-Valerolactone solvent from an initial (as processed) average surface roughness of 18.87 microns (see image on left) to a smoothed (final) average surface roughness of 3.54 microns (see image on right).

Similarly, in the microscopy image shown in FIG. 3b, the surface roughness of a powder-based additively manufactured part comprising Polyamide 12 was reduced using an γ-Butyrolactone solvent from an initial (as processed) average surface roughness of 18.87 microns (see image on left) to a smoothed (final) average roughness of 0.97 microns (see image on right).

In the microscopy image shown in FIG. 3c, the surface roughness of a powder-based additively manufactured part comprising Thermoplastic Polyurethane (TPU) was reduced using a γ-Valerolactone solvent from an initial (as processed) average surface roughness of 16.871 microns (see image on left) to a smoothed (final) average surface roughness of 0.992 microns (see image on right).

In the microscopy image shown in FIG. 3d, the surface roughness of a powder-based additively manufactured part comprising Thermoplastic Polyurethane was reduced using a γ-Butyrolactone solvent from an initial (as processed) average surface roughness of 16.871 microns (see image on left) to a smoothed (final) average surface roughness of 5.204 microns (see image on right).

In the microscopy image shown in FIG. 3e, the surface roughness of a powder-based additively manufactured part comprising Thermoplastic Polyurethane was reduced using a γ-caprolactone solvent from an initial (as processed) average surface roughness of 16.871 microns (see image on left) to a smoothed (final) average surface roughness of 1.347 microns (see image on right).

In the microscopy image shown in FIG. 3f, the surface roughness of a powder-based additively manufactured part comprising Polyamide 12 was reduced using a non-cyclic Methyl 5-(dimethylamino)-2-methyl-5-oxopentanoate solvent (CAS no 1174627-68-9) from an initial (as processed) average surface roughness of 18.87 microns (see image on left) to a smoothed (final) average surface roughness of 1.37 microns (see image on right).

In the microscopy image shown in FIG. 3g, the surface roughness of a powder-based additively manufactured part comprising Thermoplastic Polyurethane was reduced using a non-cyclic Methyl 5-(dimethylamino)-2-methyl-5-oxopentanoate solvent (CAS no 1174627-68-9) from an initial (as processed) average surface roughness of 16.871 microns (see image on left) to a smoothed (final) average surface roughness of 1.25 microns (see image on right).

In the microscopy image shown in FIG. 3h, the surface roughness of a filament-based additively manufactured part comprising Polyphenylene sulfide (or “PPS”) was reduced using a non-cyclic Methyl 5-(dimethylamino)-2-methyl-5-oxopentanoate solvent from an initial (as processed) average surface roughness of 15.6 microns (see image on left) to a smoothed (final) average surface roughness of 2.5 microns (see image on right).

In the microscopy image shown in FIG. 3i, the surface roughness of an injection moulded (non-AM) part comprising Polyphenylsulfone (PPSU) was reduced using a γ-Valerolactone solvent from an initial (as processed) average surface roughness of 2.797 microns (see image on left) to a smoothed (final) average surface roughness of 0.346 microns (see image on right).

The precise conditions under which these results were achieved are displayed in the Experimental Example section.

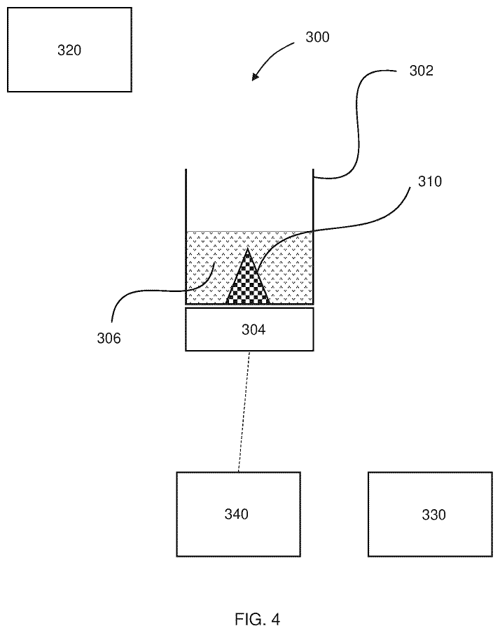

An apparatus 300 for post-processing a thermoplastic additively manufactured part according to an alternative embodiment is illustrated in FIG. 4.

The apparatus 300 is made up of a reservoir in the form of a solvent bath 302 and a heating element 304.

The solvent bath 302 is configured for storing a solvent 306 to be used during a post-processing operation, as shall be described in greater detail below. The solvent bath 302 is of a size and configuration such that an additively manufactured part 310 can be entirely submerged within the solvent 306 during the post-processing operation.

The heating element 304 is located proximal to the solvent bath 302 and is operatively coupled to a controller 340 configured to control the heating element 304 so as to heat the solvent 306 to a desired temperature during the post-processing operation.

As with the apparatus described in FIG. 1, in exemplary embodiments the apparatus 300 may form part of an additive manufacturing system, including an additive manufacturing apparatus 320 configured for additively manufactured the part 310, prior to post-processing using the apparatus 300, or may be provided as a discrete and separate system.

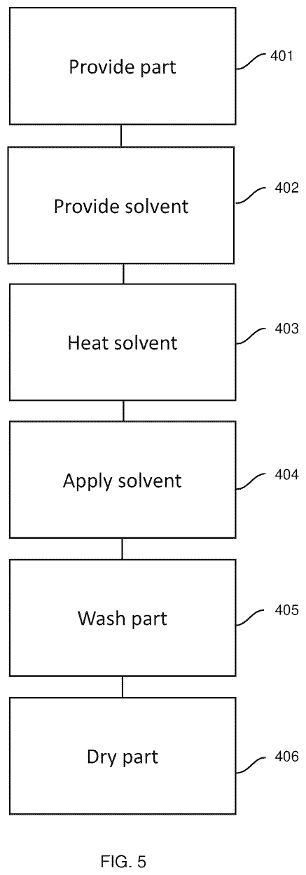

A method of post-processing an additively manufactured part according to another embodiment of the disclosure shall now be described with reference to FIGS. 4 and 5.

At a first step 401, an additively manufactured part 310 is provided. The method for providing the part 310 at step 401 is substantially the same as that which is described in step 201 of the method described for FIG. 2 and so, for conciseness, shall not be described again in this section of the application.

As with the embodiment described in FIGS. 1 and 2, in the embodiment illustrated in FIGS. 4 and 5, the additively manufactured part comprises Polyamide 12. However, it shall be appreciated that in other embodiments, other suitable materials may be processed using this aforementioned method.

At step 402 of the method, a fluid 306 is provided which comprises a carboxylic ester. As with the embodiment illustrated in FIGS. 1 and 2. In the embodiment illustrated in FIGS. 4 and 5, the carboxylic ester is a cyclic carboxylic ester namely γ-Valerolactone (such as γ-Valerolactone ReagentPlus®, 99% which is available from Sigma-Aldrich). However, it shall be appreciated that in other embodiments, other suitable carboxylic esters may be used.

Unlike in the embodiment illustrated in FIGS. 1 and 2, the fluid 306 in FIG. 4 is provided as a liquid. Once the liquid solvent 306 is provided within the solvent bath 302, the solvent 306 is heated, under atmospheric pressure, via the heating element 304 at step 403.

In the illustrated embodiment, wherein the additively manufactured part comprises Polyamide 12, the fluid 306 provided within the solvent bath was heated to a temperature of approximately 150° C. However, it shall also be appreciated that when the process is performed using different materials and/or solvents, the temperatures to which the solvent is heated may vary. For most material and solvent types, the temperature to which the solvent bath is heated will be in the range of 100° C. to 300° C., with optimal results typically being achieved at temperatures in the range of 160° C. to 200° C.

However, it shall be appreciated that for some materials with higher melting points, such as PPS, and for some solvents with higher boiling points, such as Methyl 5-(dimethylamino)-2-methyl-5-oxopentanoate, optimal results may be achieved at a higher range of temperatures, such as temperatures in the range of 120° C. to 280° C.

Once the liquid solvent has been heated to the desired temperature, the part 310 is submerged within the solvent bath 302 in order to apply the liquid solvent 306 onto the surface of the part 310, as is illustrated in step 404. It shall be appreciated however that in alternative embodiments, the part 310 may be submerged into the solvent bath 302 prior to the liquid solvent 306 being heated.

Once the part 310 has been submerged and the liquid solvent 306 is at the desired temperature, the part 310 is left within the solvent bath 302 for a period of time (i.e., an immersion time), typically in the range of 10 seconds to 1 hour, to allow for post-processing of the part 310.

For example, it has been found that a processing time of approximately 20 seconds is optimal when processing additively manufactured parts comprising Polyamide 12 using γ-Valerolactone, although it shall be appreciated that processing times may vary dependent on the material and solvent used for a given process.

Once the part 310 has been processed, the part 310 is removed from the solvent bath 302 before being washed at step 405.

In the embodiment illustrated in FIGS. 4 and 5, the part 310 is washed via rinsing with water to remove any excess solvent 306 from the part 110. However, in other embodiments, another suitable liquid such as alcohol or acetone may be used, or in yet further embodiments, the washing step may be omitted.

The part 310 is then dried at step 406. In the embodiment illustrated in FIGS. 4 and 5, the part 310 is dried via removing the part from the processing chamber 302 and placing the part into a vacuum oven 330 which heats the part to a temperature above a boiling point of the carboxylic ester solvent. This helps to remove any unwanted solvent from the part after processing, which helps to avoid any unwanted removal of material from the part or other adverse effects which may be caused by over-exposure to the solvent. However, in alternative embodiments, it shall be appreciated that different drying processes may be used.

Following the processes set out in FIGS. 1 and 2, and FIGS. 4 and 5, it has been found that the surface finish of an additively manufactured thermoplastic part can be greatly improved (as evidenced by the images provided in FIGS. 3a to 3h) without the use of halogenated compounds or benzene derivatives.

It has also been found that application steps 204 and 404 can be repeated in some embodiments to further improve the surface finish of the additively manufactured parts if further improvements are required after the first processing run.

Although the invention has been described above with reference to one or more preferred embodiments, it will be appreciated that various changes or modifications may be made without departing from the scope of the invention as defined in the appended claims.

1. A method for post-processing a thermoplastic part comprising the steps of:
a) providing a thermoplastic part,
b) providing a fluid for processing the thermoplastic part in order to improve the surface finish of the thermoplastic part, wherein the fluid comprises at least one carboxylic ester;
c) a heating step, wherein the fluid is heated; and
d) an application step, wherein the heated fluid is applied to a surface of the thermoplastic part.

2. The method according to claim 1, wherein the carboxylic ester is a cyclic carboxylic ester (lactone).

3. The method according to claim 2, wherein the cyclic carboxylic ester has the following structure: 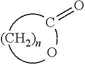
wherein n is 2 to 10.

4. The method according to claim 2, wherein the cyclic carboxylic ester comprises a four membered ring.

5. The method according to claim 4, wherein the cyclic carboxylic ester comprises a four (β-lactone), five (γ-lactone), six (δ-lactone) or seven (ε-lactone) membered ring.

6. The method according to claim 2, wherein the cyclic carboxylic ester is selected from the group consisting of β-Propiolactone, δ-pentalactone, γ-hexalactone, γ-Valerolactone, ε-Caprolactone and γ-Caprolactone.

7. The method according to claim 5, wherein the cyclic carboxylic ester comprises a five (γ-lactone) or six (δ-lactone) membered ring.

8. The method according to claim 7, wherein the cyclic carboxylic ester comprises a five (γ-lactone) membered ring.

9. The method according to claim 8, wherein the cyclic carboxylic ester is γ-Valerolactone.

10. The method according to claim 1, wherein the thermoplastic part comprises a polar polymer.

11. The method according to claim 1, wherein the heating step comprises heating the fluid to a temperature in the range of about 100° C. to about 300° C.

12. The method according to claim 1, wherein the heated fluid is applied to the surface of the thermoplastic part for an immersion time in the range of about 10 seconds to about 1 hour.

13. The method according to claim 1, wherein the fluid is provided as a liquid, and wherein the application step comprises submerging the thermoplastic part into said liquid, and the heating step comprises heating the liquid to a temperature in the range of about 140° to about 200° C.

14. The method according to claim 1, wherein step a) comprises placing the thermoplastic part into a processing chamber, wherein step c) comprises heating the fluid so as to cause the fluid to vaporise, and wherein step d) comprises introducing the vaporised fluid into the processing chamber and condensing the vaporised fluid onto the surface of the thermoplastic part contained therein.

15. The method according to claim 14, wherein the method comprises heating the vapourised fluid to a temperature in the range of about 120° C. to about 180° C.

16. The method according to claim 14, wherein an interior of the processing chamber is maintained at a pressure which is less than 100 kPa (1 Bar).

17. The method according to claim 16, wherein the method further comprises, after step d):
e) re-applying a negative pressure to the interior of the processing chamber so as to evaporate the condensed fluid from the surface of the thermoplastic part.

18. The method according to claim 1, wherein the method further comprises, after step d):
f) removing the heated fluid from the surface of the thermoplastic part; and
g) re-applying the or a heated fluid to the surface of the thermoplastic part.

19. The method according to claim 1, wherein the thermoplastic part comprises a functional group having a dipole moment greater than 0 Debye.

20. The method according to claim 1, wherein the thermoplastic part is an additively manufactured part.
